(19) United States
(12) Patent Application Publication
(10) Pub. No.: US 2007/0192835 A1
(43) Pub. Date: Aug. 16, 2007

(54) Communication device, communication system, and storage medium for storing program for communication device

(75) Inventor: Shigeki Kimura, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/276,084

(22) Filed: Feb. 14, 2006

(51) Int. Cl. H04L 9/32

(52) U.S. Cl. 726/4

(57) ABSTRACT

An image forming device is connected to a management server, capable of receiving program data sent from a development server, and includes a process acceptance unit, a determination unit, a notification unit, and a pseudo-operation activation unit. The process acceptance unit accepts the program data. The determination unit determines whether or not the program data accepted by the process acceptance unit is authorized. If it is not authorized, the notification unit notifies the management server of the unauthorized program data detected. Then, the pseudo-operation activation unit performs a pseudo-operation to create a false impression in an unauthorized user that a normal update is being performed according to the program data.

### BACKGROUND OF THE INVENTION

1. Field of the Invention

The present invention relates to a communication device. More specifically, the present invention relates to a communication device which can communicate with a management section of an organization, and accepts predetermined processes from the outside.

The present invention also relates to a communication system including such a communication device, and a storage medium storing a program to be executed by the communication device.

2. Background Information

In recent years, an image forming device such as a copying machine, a printer, or the like, is equipped with a standard communication function, which connects with an externally connected device through a network, and provides communication by transmitting and receiving various information to the externally connected device. Thus, an image forming device can be considered to be a communication device.

Various programs are stored in the communication device, including firmware for generating operating environments, etc., and can be periodically updated to new versions. For example, a new version of firmware can be downloaded to the communication device from the website of the firmware provider.

However, fraud may be committed by updating these programs with maliciously altered versions, and thereby making the communication device operate in a manner not intended by the authorized firmware provider.

This type of fraud includes, for example, updating the firmware by using an unauthorized update program in order to distribute image data stored in the device to the outside without the user's knowledge.

When updating firmware with an unauthorized update program, an unauthorized person may gain access to the communication device. The generation of an audible alarm has been proposed as a countermeasure against unauthorized access, as well as recording the access source address, the access time, and the content of the access, when unauthorized access has been detected.

Japan Unexamined Patent Application Publication Nos. 2003-50842 and 2003-58669 show examples of these conventional techniques.

However, with the above-described conventional techniques, it is difficult to identify the unauthorized user in the act of fraud. An audible alarm warns the unauthorized user to escape before the unauthorized user can be identified.

It is also difficult to detain the unauthorized user by analyzing the data recorded in the device afterwards.

In view of the above, it will be apparent to those skilled in the art from this disclosure that there exists a need to easily identify an unauthorized person in the act of fraud when accessing a communication device. This invention addresses this need in the art as well as other needs, which will become apparent to those skilled in the art from this disclosure.

### SUMMARY OF THE INVENTION

A communication device according to a first aspect of the present invention is connected to a management section of an organization so as to allow communication therewith, and accepts a predetermined process from the outside, comprises a process acceptance unit, a determination unit, a notification unit, and a pseudo-operation activation unit. The process acceptance unit accepts the predetermined process. The determination unit determines whether or not the process accepted by the process acceptance unit is an authorized process. If it is an unauthorized process, the notification unit notifies the management section of the unauthorized process detected. The pseudo-operation activation unit performs a pseudo-operation to create a false impression as if the unauthorized process is being accepted.

When the communication device has detected an unauthorized process, the management section will be notified, and the pseudo-operation will be performed. The unauthorized user will not sense the detection and continue with the act, and thereby provide the management section time to identify the unauthorized user.

A predetermined process refers to actions such as accessing the communication device, downloading program data to the communication device via a connection to an external site, and updating the program data in the communication device by means of the downloaded program data.

The pseudo-operation is an operation which creates a false impression in the unauthorized user that the unauthorized process is being accepted. Messages showing the acceptance of the actions performed by the unauthorized user are displayed, showing access to the communication device being permitted, and the program data being downloaded. Audible alarms and other means that might alert the unauthorized user to the fact that he or she has been detected are avoided in order to provide sufficient time to identify the unauthorized user before he or she can escape.

The management section includes a server computer or the like that is located near the location of the person in charge of managing the communication device. Notifications to the management section could be in the form of e-mails, instant messages, voice messages, and/or a message transmissions to a dedicated tool utilized in the management section.

A communication device is a device capable of communicating with an external device, for example, office equipment such as an image forming device, and home electric appliances.

An authorized process refers to the process by which an authorized person accesses the communication device, and downloads and updates program data. An authorized person is one who has been pre-registered as such.

According to a second aspect of the present invention, a communication device can be operated based on the program data obtained from an externally connected device, and the pseudo-operation activation unit can perform a pseudo-operation that will give an unauthorized user the impression that the program data is being updated.

When an attempt to update the program data using an unauthorized program data is detected, the pseudo-operation activation unit performs a pseudo-operation to create a false impression to deceive the unauthorized user as if the process is being accepted.

While the pseudo-operation convinces the unauthorized user that the update has succeeded by providing false messages to him or her, the management section will have sufficient time to identify the unauthorized user.

The program data herein includes software, such as firmware, application software, and drivers. The pseudo-operation includes the display of messages such as “update proceeding”, and the display of an indicator showing that an update is being performed.

A notification will be sent to the management section that includes data identifying the externally connected device, such as the name of the device, the IP address, and the MAC address.

The externally connected device is connected to the communication device via a network, or a local area connection.

According to a third aspect of the present invention, the pseudo-operation activation unit not only deceives the unauthorized user, but can also requests the externally connected device to transmit the program data again in order to provide the management section more time to identify the unauthorized user.

According to a fourth aspect of the present invention, the communication device further comprises an input unit that request authentication data from the user. The pseudo-operation activation unit also requests authentication data, which serves as useful information to identify the unauthorized user.

Requesting authentication data provides the management section more time to identify the unauthorized user.

According to a fifth aspect of the present invention, a communication system comprises the communication device of the first aspect, a management section, and an externally connected device. The management section and the externally connected device are capable of communicating with the communication device. The management section manages the communication device.

The communication device of the first aspect deceives the unauthorized user into believing that the process is being accepted, which allows time for the management section to identify the unauthorized user during the fraudulent act.

A storage medium according to a sixth aspect of the present invention stores a communication program to be executed by a computer in a communication device, and can accept a predetermined process from the outside. The communication program enables the computer to perform a process acceptance function, a determination function, a notification function, and a pseudo-operation activation function. The process acceptance function accepts the predetermined process. The determination function determines whether or not the process accepted by the process acceptance function is an authorized process. The notification function notifies a management section that manages the communication device when an unauthorized process is detected. The pseudo-operation activation function performs a pseudo-operation in order to create a false impression in an unauthorized user that an unauthorized process provided by the unauthorized is being accepted by the communication device.

According to a seventh aspect of the present invention, the communication device can be operated based on program data obtained from an externally connected device. The pseudo-operation activation function performs a pseudo-operation when an unauthorized process is detected, in order to create a false impression in an unauthorized user that the program data is being updated.

According to an eighth aspect of the present invention, the pseudo-operation activation function can request the externally connected device to transmit the program data again.

According to a ninth aspect of the present invention, the communication program enables the computer to perform an input function that requests authentication data from a user. The pseudo-operation activation function also requests authentication data from a user.

When an external process is accepted, an image forming device determines whether or not the process is authorized. If the process is unauthorized, the image forming device notifies the management section of the unauthorized process detected, and performs a pseudo-operation. The person attempting unauthorized access will be deceived by a false impression that the process has been accepted. This provides the management section will sufficient time to identify the unauthorized person before he or she can escape.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block diagram showing the configuration of an image forming system according to one embodiment of the present invention.

FIG. 2 is a block diagram showing the functional configuration of an image forming device.

FIG. 3 is a flowchart showing the operation of the image forming system of FIG. 2.

FIG. 4 is a flowchart showing the operation of an image forming system according to another embodiment of the present invention.

FIG. 5 is a flowchart showing the operation of an image forming system according to another embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

Configuration of Image Forming System

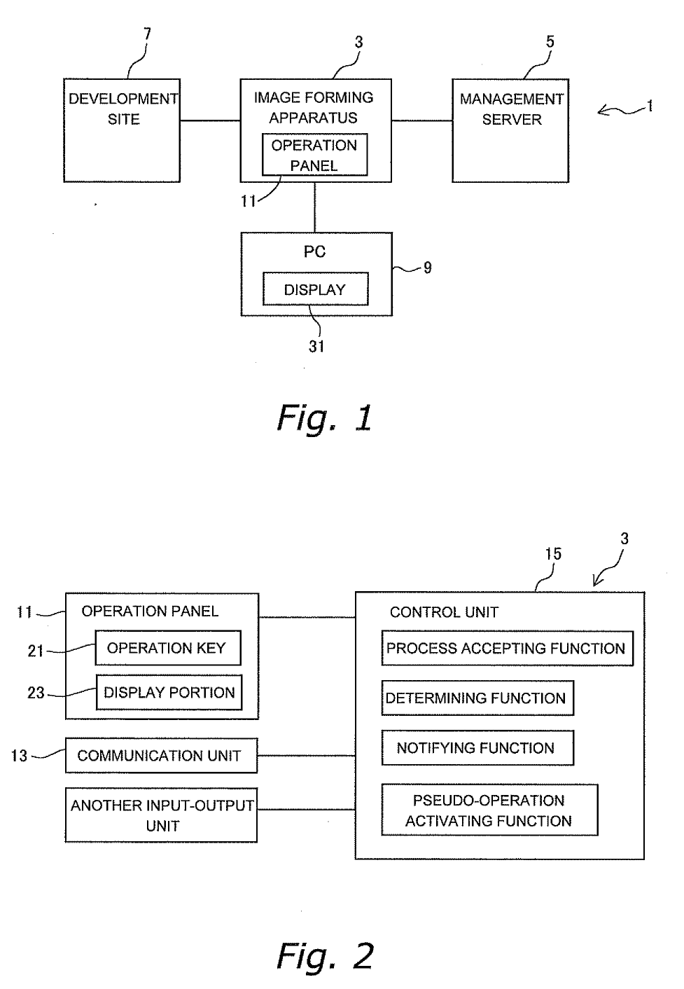

FIG. 1 shows the configuration of an image forming system 1 according to one embodiment of the present invention.

The image forming system 1 comprises an image forming device 3, a management server 5 (management section), and a development server 7 (externally connected device). The management server 5 is a server provided where a manager of the image forming device 3 is located, and is connected to the image forming device 3 via a network.

The development server 7 is a server provided at a development section that develops various program data to be utilized in the image forming device 3, and is connected to the image forming device 3 via a network. The program data stored here includes firmware and the like.

Note that a PC 9 is provided outside of the image forming system 1 and is connected to the image forming device 3 via a network. Assume that the PC 9 stores a maliciously altered update program for firmware.

Image Forming Device

An image forming device 3 is a multifunction device functioning as a copying machine, a printer, a fax machine, and a scanner in combination. As shown in FIG. 2, it is comprised of an operation panel 11 (input unit, pseudo-operation activation unit), a communication unit 13 (process acceptance unit, notification unit), a control unit 15 (determination unit), and other input-output units.

The operation panel 11 includes a plurality of operation keys 21, and a display portion 23 formed by a touch panel type liquid crystal display.

The operation keys 21 include a start key that commands a print operation, a numeric keypad for inputting numerical values, and various setting keys.

The display portion 23 displays various operation screens including a standby screen, and accepts operation content in response to a user touching the touch panel. The operation screen includes an update screen showing that an update is being performed by the program data received from the development server 7.

The update screen is displayed not only when an update is performed by firmware authorized by the development section, but also when an update is performed by a maliciously altered firmware. However, when a maliciously altered firmware is detected, only an update screen is displayed, and the firmware does not actually perform the update operation. An ID and password (authentication data) belonging to a user can be input into an authentication screen.

The communication unit 13 serves as a means of communication between the development server 7 and the management server 5. For example, the communication unit 13 notifies the management server 5 when program data from the development server 7 or unauthorized program data from an external source is received. In addition, the communication unit 13 is capable of communicating with the PC 9.

When an unauthorized program data is detected, the communication unit 13 will notify the management server 5 stealthily, e.g., without sounding an audible or visual alarm, so as to not alert a unauthorized user that he or she has been detected.

The control unit 15 is comprised of a microcomputer including a CPU and a memory. The control unit 15 controls the input-output unit, and performs image processing.

The memory stores various programs to be executed by the CPU. The programs stored include firmware, applications software, as well as an unauthorized access counter program, described below in detail.

The firmware can be updated by the program data obtained from the development server 7.

The unauthorized access counter program, when executed by the CPU, performs a process acceptance function, a determination function, a notification function, and a pseudo-operation activation function.

The process acceptance function accepts access through operation of the operation panel 11 and access from the PC 9 via the communication unit 13. The process acceptance function also accepts transmission of unauthorized program data stored in the PC 9 according to an operation performed by the PC 9, transmission of unauthorized program data from another server besides the PC 9 that stores unauthorized program data, and update to the firmware already stored in the image forming device 3 by unauthorized programs.

The determination function determines whether or not the various processes accepted by the process acceptance function are authorized. This is performed in the same manner as the method utilized for authentication of electronic signatures using a hash function.

Hash values are compared when verifying whether or not a program data received from the development server 7 is authorized program data. The development server 7 encrypts the program data with a private key, and obtains a hash value by utilizing the hash function. Also, the image forming device 3 encrypts the program data with a public key, calculates a hash value of the received program data, and then compares the received hash value with the hash value of the decrypted program data. As a result, if the two hash values are equal, it is authorized program data. On the other hand, if the two hash values are different, it is unauthorized program data.

If the determination function detects unauthorized process data, the notifying function of the image forming device 3 notifies the management server 5 via the communication unit 13 of that face by e-mail.

Then, the pseudo-operation activating function performs a pseudo-operation to create a false impression as if the process acceptance is being accepted. An update screen is displayed as if the update by the unauthorized program data is successfully performed. Note that the pseudo-operation activating function also causes the communication unit 13 to display an update screen on the display 31 of the PC 9, which will be described in detail later.

The registered IDs and passwords of authorized users that can utilize the image forming device 3 are stored in the memory. In addition, the memory can also store the IP address and the MAC address of a transmission source to identify the transmission source of the program data.

The other input-output units of the image forming device 3, not shown on the figures, include an image reading unit for reading an image, and an image forming unit for forming an image on a paper.

Note that the PC 9 has the display 31 (input unit) as an output device, that displays the same update screen as displayed on the display portion 23 of the operation panel 11 by the pseudo-operation activating function of the image forming device 3.

Operation of Image Forming System

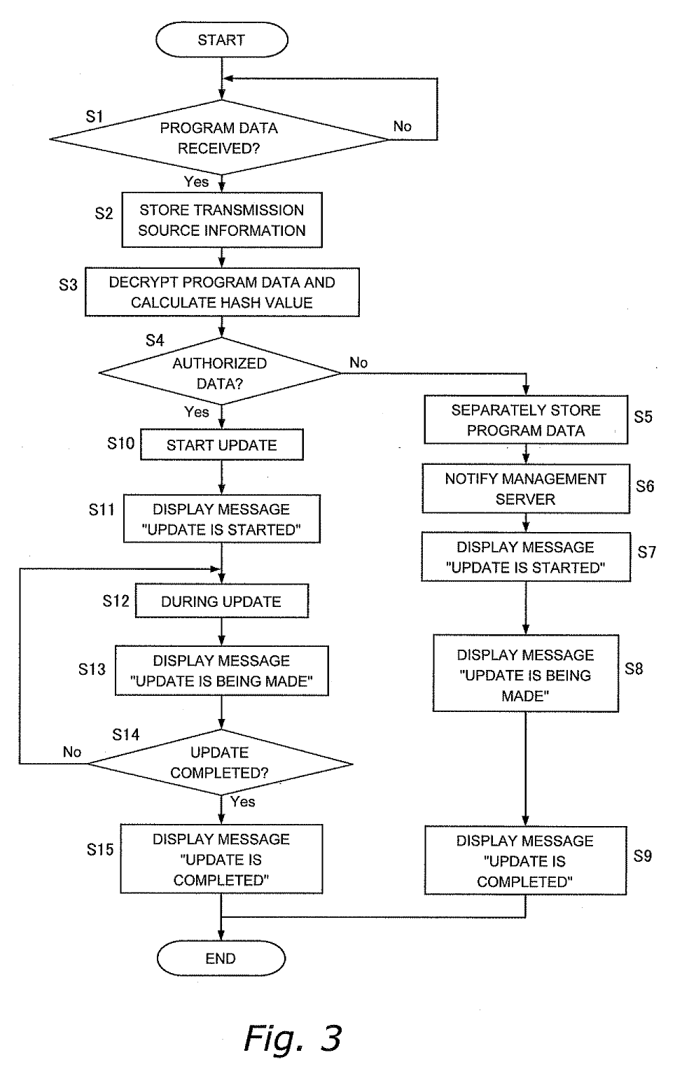

A description of the operation of the image forming system 1 will be provided below with reference to FIG. 3.

The operations performed after the detection of unauthorized program data obtained from an external source will be described below.

When a predetermined operation is performed on the PC 9 to transmit firmware update program data to the image forming device 3, the image forming device 3 receives that data (S1), stores the transmission source information, such as an IP address of the PC 9, in the memory (S2), and decrypts the program data to calculate a hash value (S3).

The calculated hash value and the hash value of the authorized update program are compared to determine whether or not the program data is an authorized program data (S4). In this case, because the hash values are different, it is unauthorized program data, and therefore the program data is stored separately from other data in the memory (S5). Then, a notification is transmitted to the management server 5 together with the transmission source information via e-mail (S6).

A message showing the start of firmware update is displayed on the operation panel 11 and the display 31 of the PC 9 (S7), a message showing that the firmware is being updated is then displayed (S8), and finally, a message showing that the update has been completed (S9) is displayed.

When authorized program data is received from the development server 7 (S1), the hash values calculated in the image forming device 3 and the hash value of the received program data are the same, and thus it is verified to be an authorized program data (S4). In this case, a normal update process will start (S10), and a message showing the start of an update (S11), a message showing the update process being orderly performed (S12), a message showing the program data being updating (S13), a message showing the end of the update process (S14), and a message showing that the update is complete (S15), are displayed.

However, if an unauthorized program data is received from the PC 9, the image forming device 3 performs a pseudo-operation without alarming the unauthorized user. The unauthorized user will be convinced that the process is being accepted.

On the other hand, a notification is sent to the management server 5, allowing time to identify the PC 9 based on the transmission source information, which enhances the possibility of identifying the unauthorized user before he or she can escape.

Other Embodiments

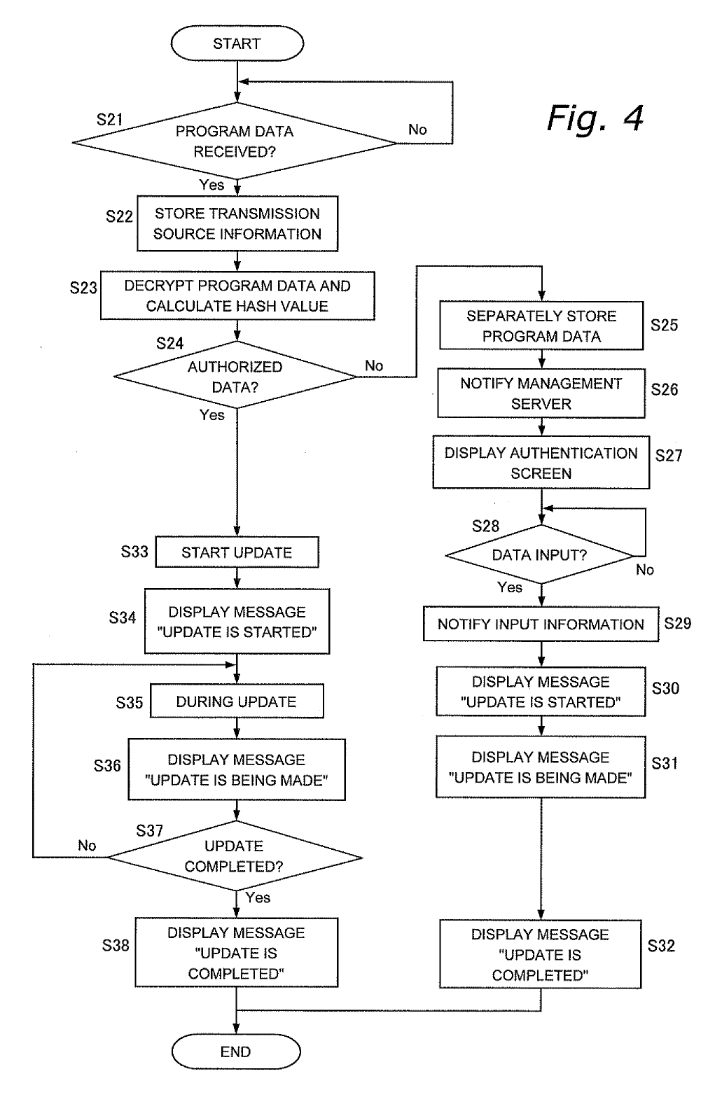

(a) In another embodiment, the image forming device 3 displays an authentication screen on the operation panel and the display 31 of the PC 9 requesting authentication data from the user when it has detected an unauthorized update attempt. An example of the operation according this embodiment is shown in FIG. 4.

Note that the process in steps S21 to S26 shown in FIG. 4 is the same as the process in steps S1 to S6 shown in FIG. 3, and the steps S30 to S38 shown in FIG. 4 is the same as steps S7 to S 15 shown in FIG. 3.

If unauthorized data is detected in step S24 shown in FIG. 4, a notification is sent to the management server in step S26, and then an authentication screen is displayed on the operation panel and the display 31 of the PC 9 (S27). If authentication data is input into the authentication screen (S28), the input data is transmitted to the management server (S29). Then, a pseudo-operation similar to steps S7 to S9 in FIG. 3 is performed (S30 to S32).

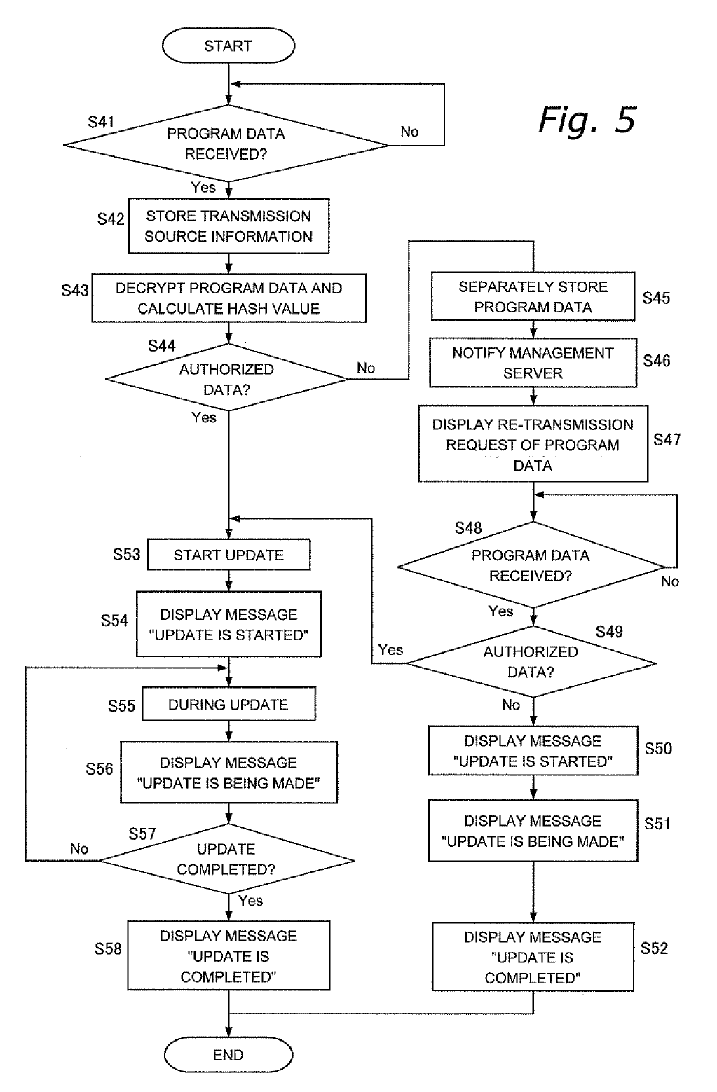

(b) Alternately, the image forming device 3 can request the PC 9 to transmit the unauthorized program data again, when an attempt to perform an unauthorized update has been detected. An example of this operation is shown in FIG. 5.

Note that the process of steps S41 to S46 in FIG. 5 is similar to the process of steps SI to S6 in FIG. 3, and the process of steps S50 to S58 in FIG. 5 is similar to the process of steps S7 to S15 in FIG. 3.

If unauthorized data is detected in step S44 shown in FIG. 5, a notification is sent to the management server in step S46, and then a message that requests the transmission of the program data again is displayed on the operation panel and the display 31 of the PC 9 (S47). Then, when the program data is transmitted again from the PC 9 (S48), it will be determined whether or not the transmitted program data is authorized (S49). If it is authorized data, the process proceeds to step S53. If it is not authorized data, a pseudo-operation is performed similar to that in steps S7 to S9 shown in FIG. 3 (S50 to S52).

(c) In the present invention, an unauthorized update is not limited to being performed by a PC 9 connected via a network to the image forming device 3, but can also be performed by externally connected devices via a local area connection to the image forming device 3. The manner in which the local area connection is achieved includes connecting an externally connected device directly via a USB port provided on the image forming device 3.

(d) The method of verifying whether or not a process input from the outside is authorized is not limited to the method of comparing the hash values described above.

Other methods may be employed.

(e) The notification to the management server can be made by e-mail transmission, transmission of an instant message, a voice message utilizing a telephone, and/or a message to a dedicated tool in the management section.

(f) The communication device of the present invention is not limited to an image forming device, and is applicable to various devices such as home electric appliances, energy consumption appliances including air-conditioning equipment, heaters, and the like, so as long as they are operated according to predetermined program data and comprise a communication function.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A communication device, comprising:
a process acceptance unit that is capable of accepting a predetermined process from an external source;
a determination unit that determines whether or not the process accepted by the process acceptance unit is an authorized process;
a notification unit that provides notification that an unauthorized process has been detected if the predetermined process is determined to be an unauthorized process; and
a pseudo-operation activation unit for performing a pseudo-operation that will create a false impression in an unauthorized user that the predetermined process has been accepted as an authorized process when the predetermined process is an unauthorized process.

2. A communication device according to claim 1, wherein the communication device can be operated in accordance with the program data obtained from an externally connected device; and
the pseudo-operation activation unit performs a pseudo-operation to crease a false impression in an unauthorized user that the program data is being updated.

3. A communication device according to claim 2, wherein the pseudo-operation activation unit is capable of performing a pseudo-operation that requests the externally connected device to transmit the program data again.

4. A communication device according to claim 2, further comprising an input unit that requests authentication data from a user in order to verify that the user has the authority to use the communication device; and
wherein the pseudo-operation activation unit is capable of performing a pseudo-operation that requests input of authentication data from a user.

5. A communication system, comprising:
a communication device according to claim 1, the communication device capable of communicating with a manager who manages the communication device; and
an externally connected device that is capable of communicating with the communication device.

6. A storage medium for storing a communication program to be executed by a computer utilized in a communication device, the communication program causing the computer to execute functions comprising:
a process acceptance function that allows the communication device to accept a predetermined process;
a determination function that determines whether or not a process accepted by the process acceptance function is an authorized process;
a notification function that provides notification that an unauthorized process has been detected when the predetermined process is an unauthorized process; and
a pseudo-operation activation function that performs a pseudo-operation in order to create a false impression in an unauthorized user that the predetermined process is being accepted as an authorized process if it is an unauthorized process.

7. A storage medium according to claim 6, wherein the communication device can be operated in accordance with program data obtained from an externally connected device; and
the pseudo-operation activation function is capable of performing a pseudo-operation that will create a false impression in an unauthorized user that the program data is being updated.

8. A storage medium according to claim 7, wherein the pseudo-operation activation function is capable of performing a pseudo-operation that requests the externally connected device to transmit program data again.

9. A storage medium according to claim 7, wherein the program for the communication device allows the computer to execute an input function that requests authentication data from a user in order to verify that a user has the authority to utilize the communication device; and
the pseudo-operation activation function is capable of performing a pseudo-operation which requests input of authentication data.
